(19) United States
(12) Patent Application Publication
(10) Pub. No.: US 2014/0271998 A1
(43) Pub. Date: Sep. 18, 2014

(54) Fortified egg white products

(71) Applicant: Aryeh HECHT, New York, NY (US)

(72) Inventor: Aryeh HECHT, New York, NY (US)

(21) Appl. No.: 13/815,719

(22) Filed: Mar. 15, 2013

(51) Int. Cl. A23L 1/32

(52) U.S. Cl. CPC A23L 1/3204
USPC 426/72; 426/301

(57) ABSTRACT

Egg products are produced which contain healthy components of egg yolks and egg whites, such as choline, lutein, omega-3 fatty acids, vitamins and minerals, but do not contain the unhealthy components of egg yolks such as cholesterol and triglycerides. The healthy yolk components or nutrients are added to egg whites to obtain a yolk-less egg product having the taste, color, and functionality of whole eggs and whole egg products. To avoid a significant off flavor from choline, while promoting brain health, it is employed in an amount of at least 25 mg per 60 g serving, but when the amount of choline is greater than 75 mg per 60 g serving size, the egg product further includes a taste masking amount of a masking agent for the choline. The fortified yolk-less liquid egg product may be used to produce a cooked food product, such as an egg patty.

### FIELD OF THE INVENTION

The present invention relates to fortified egg white products, such as an egg patty, which is fortified with healthy components including choline, lutein, omega-3 fatty acids, and vitamins and minerals contained in the yolk, but which does not contain unhealthy yolk components such as cholesterol. The present invention also relates to processes for making the fortified egg white products.

### BACKGROUND

The egg yolk contains many healthy components, such as choline, omega-3 fatty acids, vitamins A, D, E, B12, calcium, phosphorous, and zinc, which are not present or which are present to a much lesser extent in the egg white. Unfortunately, the egg yolk also contains unhealthy components, such as cholesterol and triglycerides which are not present in egg white. For example, as disclosed in U.S. Patent Publication No. 2008/0003335, the disclosure of which is herein incorporated by reference in its entirety, egg white does not contain any lipids, vitamin A, D, or E, or zinc, whereas egg yolk contains approximately 4.428 g fatty acids as triglycerides, 1.586 g saturated and 1.949 g monounsaturated, 0.698 g polyunsaturated, and 213 g cholesterol, 323 IU Vitamin A, 24.5 IU Vitamin D, 0.7 mg. Vitamin E, and 0.52 mg of zinc. Additionally, as disclosed therein, the egg yolk contains about 216 mg of choline, 23 mg calcium, 81 mg phosphorus, but the egg white contains only 0.42 mg of choline, 2 mg calcium, and 4 mg phosphorus. Also, egg white contains more protein and more amino acids than does the egg yolk.

International Patent Publication No. WO 2007/146249 to Singh et al discloses production of a reduced egg product by supercritical fluid extraction comprising egg yolk from a whole egg that has a portion of undesired components, such as cholesterol and triglycerides (including saturated fats), selectively removed from the natural egg yolk while the beneficial components, such as phospholipids, are selectively retained and while the consumer-desired flavor, texture, and/or functionality of the egg yolk is retained.

U.S. Patent Application Publication No. 2010/0040737 to Radio et al discloses egg whites which are combined with phytosterols to reduce cholesterol, and other ingredients, such as omega-3 fatty acids.

Choline serves various bodily functions including providing structure of cell membranes, protecting livers from accumulating fat, and as the precursor molecule for the neurotransmitter acetylcholine. Choline started to get the interest of nutrition researchers when it was found that fetal rats whose mothers didn't get enough choline in their diets had less brain development and poorer memories after birth than those whose mothers ate adequate amounts of the nutrient. Choline may be essential not only for the brain development of fetuses and infants, but may help prevent memory loss associated with aging. Choline has been shown to protect the liver from certain types of damage, and can help reverse damage that has already occurred. Additionally, it may help lower cholesterol and homocysteine levels associated with cardiovascular disease, and may also help protect against some types of cancers.

Accordingly, there is a long felt need for a method of producing egg products which contain healthy components of egg yolks and egg whites, such as choline, lutein, omega-3 fatty acids, vitamins and minerals, proteins and amino acids, but do not contain the unhealthy components of egg yolks such as cholesterol and triglycerides, without the need for removal of the unhealthy egg yolk components by extraction or other processes, while achieving the taste, color, and functionality of whole egg products.

### SUMMARY OF THE INVENTION

In an embodiment, a fortified yolk-less liquid egg product includes egg whites, at least one omega-3 fatty acid, lutein, beta-carotene, vitamins and minerals, and choline wherein the amount of choline is at least 25 mg per 60 g serving size of the liquid egg product, and when the amount of choline is greater than 75 mg per 60 g serving size, the egg product further includes a taste masking effective amount of a masking agent for the choline. Use of the lower amount of choline or use of the higher amount of choline with the masking agent avoids a strong, spinach-like taste in the yolkless liquid egg product and food products containing it, while providing a nutritionally effective amount of choline for promoting brain health. In embodiments where the amount of choline is from 25 mg to 75 mg per 60 g serving size, preferably from 35 mg to 60 mg per 60 g serving size, a masking agent is not needed to avoid the strong taste of choline. When the amount of choline is greater than 75 mg per 60 g serving size, preferably from 105 mg to 230 mg per 60 g serving size, a masking agent, such as a flavoring, a film-forming component, or a protective coating which encapsulates the choline is employed to mask the strong taste of choline. In embodiments, the fortified yolk-less egg products are cholesterol free and triglyceride free and contain at least the natural amount of at least three nutritional components of a natural egg yolk, such as omega-3 fatty acids, lutein, beta-carotene, zinc, Vitamin D, and Vitamin E which are not present in natural egg white.

In an embodiment, a food product is provided which includes a cooked fortified yolkless liquid egg product, such as an egg patty, which includes egg whites, at least one omega-3 fatty acid, lutein, beta-carotene, vitamins and minerals, and choline wherein the amount of choline is at least 25 mg per 60 g serving size of the liquid egg product, and when the amount of choline is greater than 75 mg per 60 g serving size, the egg product further includes a taste masking effective amount of a masking agent for the choline. In embodiments, the fortified yolk-less egg products are cholesterol free and triglyceride free and contain at least the natural amount of at least three nutritional components of a natural egg yolk, such as omega-3 fatty acids, lutein, beta-carotene, zinc, Vitamin D, and Vitamin E which are not present in natural egg white. In aspects of the invention, the fortified yolk-less egg products may further include at least one ingredient which is a gum, natural flavoring, artificial flavoring, sweetener, sugar, oil, or mixtures thereof.

In embodiments, a fortified yolk-less liquid egg product may be made by admixing liquid egg white, at least one omega-3 fatty acid, lutein, beta-carotene, vitamins and minerals, and choline to obtain a homogeneous liquid blend, wherein the amount of choline is at least 25 mg per 60 g serving size of the liquid egg product. When the amount of choline is greater than 75 mg per 60 g serving size, the egg product further includes a taste masking effective amount of a masking agent for the choline. The liquid blend may be pasteurized, cooled, and packaged. In embodiments, the at least one omega-3 fatty acid may be admixed with the other ingredients either after cooling of the pasteurized blend or before pasteurization of the liquid blend. In embodiments, the vitamins, minerals, beta-carotene and lutein may be preblended prior to admixing with the at least one omega-3 fatty acid, and the choline, and the liquid egg whites.

In an aspect of the present invention, a fortified yolk-less food product may be produced by cooking a fortified yolk-less liquid egg product which includes egg whites, at least one omega-3 fatty acid, lutein, beta-carotene, vitamins and minerals, and choline wherein the amount of choline is at least 25 mg per 60 g serving size of the liquid egg product. However, in embodiments, when the amount of choline is greater than 75 mg per 60 g serving size, the egg product further includes a taste masking effective amount of a masking agent for the choline. In embodiments, the fortified yolk-less liquid egg product may be admixed with at least one ingredient which is a gum, natural flavoring, artificial flavoring, sweetener, sugar, oil, or mixtures thereof to obtain a homogeneous liquid egg product. The liquid egg product may be cooked to obtain a yolk-less food product with a choline content of at least 25 mg per 60 g serving size, based upon the weight of the food product. The yolkless food product may be formed into pieces and frozen.

In an embodiment, a fortified yolk-less egg patty may be produced by admixing egg whites, water, at least one omega-3 fatty acid, lutein, beta-carotene, vitamins and minerals, and choline to obtain a homogeneous liquid egg product wherein the amount of choline is at least 25 mg per 60 g serving size of the liquid egg product. However, when the amount of choline is greater than 75 mg per 60 g serving size, the egg product further includes a taste masking amount of a masking agent for the choline. The liquid egg product poured into a mold, and the liquid egg product is cooked in the mold to obtain a yolk-less egg patty with a choline content of at least 25 mg per 60 g serving size, based upon the weight of the egg patty. The yolkless egg patty may be frozen after removal from the mold, and stored. The vitamins, minerals, beta-carotene and lutein may be preblended prior to admixing with the at least one omega-3 fatty acid and the choline, and the egg whites.

### BRIEF DESCRIPTION OF THE DRAWINGS

The present invention is further illustrated by the accompanying drawings wherein:

FIG. 1 is a flow chart showing a process for making a fortified yolk-less liquid egg product of the present invention.

FIG. 2 is a flow chart showing an alternative process for making a fortified yolk-less liquid egg product of the present invention.

### DETAILED DESCRIPTION OF THE INVENTION

Reference now will be made to certain detailed aspects of various embodiments of the invention. It is to be understood that the disclosed embodiments are merely exemplary of the invention that may be embodied in numerous and alternative forms. Therefore, specific details disclosed herein are not to be interpreted as limiting, but merely as a representative basis for any aspect of the invention and/or as a representative basis for teaching one skilled in the art to variously employ the invention.

Except in the examples, or where otherwise expressly indicated, all numerical quantities in this description indicating amounts of material and/or use are to be understood as modified by the word “about” in describing the broadest scope of the invention. Practice within the numerical limits stated is generally preferred.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application in their entirety to more fully describe the state of the art to which this invention pertains.

It is noted that terms such as “natural whole egg,” “natural amount,” “natural egg yolk,” “natural egg white,” “naturally present,” refer to the compositions (e.g. whole egg, egg yolk, egg white) or amounts as occurring in nature for the raw, fresh product such as nutrient amounts or data provided by various sources such as USDA Agricultural Research Service, National Agricultural Library, National Nutrient Database for Standard Reference, Release25, “Nutrient data for 01123, Egg, whole, raw, fresh” available at http://ndb.nal.usda.gov/ndb/foods/show/111, and in the Table at page 4 of U.S. Patent Application Publication No. 2008/0003335, the disclosures of which are herein incorporated by reference in their entireties. For example, the USDA nutrient data for 01123, Egg, whole, raw, fresh is shown in Table 1:

TABLE 1
Nutrient data for 01123, Egg, whole, raw, fresh

| | | | 1.0 | | | | | |
|---|---|---|---|---|---|---|---|---|
| | | | cup (4.86 | 1.0 | | | | |
| | | 1 | large | extra | 1.0 | 1.0 | 1.0 | 1.0 |
| | | Value per | eggs) | large | jumbo | large | medium | small |
| Nutrient | Unit | 100.0 g | 243 g | 56 g | 63 g | 50 g | 44 g | 38 g |
| Proximates | | | | | | | | |
| Water | g | 76.15 | 185.04 | 42.64 | 47.97 | 38.08 | 33.51 | 28.94 |
| Energy | kcal | 143 | 347 | 80 | 90 | 72 | 63 | 54 |
| Protein | g | 12.56 | 30.52 | 7.03 | 7.91 | 6.28 | 5.53 | 4.77 |
| Total lipid (fat) | g | 9.51 | 23.11 | 5.33 | 5.99 | 4.76 | 4.18 | 3.61 |
| Carbohydrate, by | g | 0.72 | 1.75 | 0.40 | 0.45 | 0.36 | 0.32 | 0.27 |
| difference | | | | | | | | |
| Fiber, total | g | 0.0 | 0.0 | 0.0 | 0.0 | 0.0 | 0.0 | 0.0 |
| dietary | | | | | | | | |
| Sugars, total | g | 0.37 | 0.90 | 0.21 | 0.23 | 0.18 | 0.16 | 0.14 |
| Minerals | | | | | | | | |
| Calcium, Ca | mg | 56 | 136 | 31 | 35 | 28 | 25 | 21 |
| Iron, Fe | mg | 1.75 | 4.25 | 0.98 | 1.10 | 0.88 | 0.77 | 0.66 |
| Magnesium, Mg | mg | 12 | 29 | 7 | 8 | 6 | 5 | 5 |
| Phosphorus, P | mg | 198 | 481 | 111 | 125 | 99 | 87 | 75 |
| Potassium, K | mg | 138 | 335 | 77 | 87 | 69 | 61 | 52 |
| Sodium, Na | mg | 142 | 345 | 80 | 89 | 71 | 62 | 54 |
| Zinc, Zn | mg | 1.29 | 3.13 | 0.72 | 0.81 | 0.64 | 0.57 | 0.49 |
| Vitamins | | | | | | | | |
| Vitamin C, total | mg | 0.0 | 0.0 | 0.0 | 0.0 | 0.0 | 0.0 | 0.0 |
| ascorbic acid | | | | | | | | |
| Thiamin | mg | 0.040 | 0.097 | 0.022 | 0.025 | 0.020 | 0.018 | 0.015 |
| Riboflavin | mg | 0.457 | 1.111 | 0.256 | 0.588 | 0.228 | 0.201 | 0.174 |
| Niacin | mg | 0.075 | 0.182 | 0.042 | 0.047 | 0.038 | 0.033 | 0.028 |
| Vitamin B-6 | mg | 0.170 | 0.413 | 0.095 | 0.107 | 0.085 | 0.075 | 0.065 |
| Folate, DFE | μg | 47 | 114 | 26 | 30 | 24 | 21 | 18 |
| Vitamin B-12 | μg | 0.89 | 2.16 | 0.50 | 0.56 | 0.44 | 0.39 | 0.34 |
| Vitamin A, RAE | μg | 160 | 389 | 90 | 101 | 80 | 70 | 61 |
| Vitamin A, IU | IU | 540 | 1312 | 302 | 340 | 270 | 238 | 205 |
| Vitamin E (alpha- | mg | 1.05 | 2.55 | 0.59 | 0.66 | 0.52 | 0.46 | 0.40 |
| tocopherol) | | | | | | | | |
| Vitamin D (D2 + | μg | 2.0 | 4.9 | 1.1 | 1.3 | 1.0 | 0.9 | 0.8 |
| D3) | | | | | | | | |
| Vitamin D | IU | 82 | 199 | 46 | 52 | 41 | 36 | 31 |
| Vitamin K | μg | 0.3 | 0.7 | 0.2 | 0.2 | 0.2 | 0.1 | 0.1 |
| (phylloquinone) | | | | | | | | |
| Lipids | | | | | | | | |
| Fatty acids, total | g | 3.126 | 7.596 | 1.751 | 1.969 | 1.563 | 1.375 | 1.188 |
| saturated | | | | | | | | |
| Fatty acids, total | g | 3.658 | 8.889 | 2.048 | 2.305 | 1.829 | 1.610 | 1.390 |
| monounsaturated | | | | | | | | |
| Fatty acids, total | g | 1.911 | 4.644 | 1.070 | 1.204 | 0.956 | 0.841 | 0.726 |
| polyunsaturated | | | | | | | | |
| Cholesterol | mg | 372 | 904 | 208 | 234 | 186 | 164 | 141 |
| Other | | | | | | | | |
| Caffeine | mg | 0 | 0 | 0 | 0 | 0 | 0 | 0 |

Nutrient values and weights are for edible portion
National Nutrient Database for Standard Reference Release 25 Software v.1.2.2

In embodiments of the invention, egg products are produced which contain healthy components of egg yolks and egg whites, such as choline, lutein, omega-3 fatty acids, vitamins and minerals, proteins and amino acids, but do not contain the unhealthy components of egg yolks such as cholesterol and triglycerides, by adding the healthy yolk components or nutrients to egg whites to obtain a yolk-less egg product having the taste, color, and functionality of whole eggs and whole egg product. It has been found that the addition of choline to egg whites in amounts naturally present in whole eggs, which is about 216 mg per 60 g serving size, imparts a strong, generally undesirable spinach-like taste to the egg whites and yolk-less egg product. Use of a lower amount of choline or use of the higher amount of choline with the masking agent avoids a strong, spinach-like taste in the yolkless liquid egg product and food products containing it, while providing a nutritionally effective amount of choline for promoting brain health. In embodiments, the fortified yolk-less liquid egg product includes egg whites, and the brain healthy nutrient choline in a nutritionally effective amount of at least 25 mg per 60 g serving size. It has been found that when the amount of choline is from 25 mg per 60 g serving to 75 mg per 60 mg serving, preferably from 35 mg to 60 mg per 60 g serving size, there is no significant off-flavor or spinach taste from choline in the liquid egg product or cooked egg products containing the liquid egg product. While it is highly desirable to employ amounts of choline greater than 75 mg per 60 g serving size, for its brain healthy effects, the off flavors tend to increase, particularly at levels greater than 150 mg per 60 g serving size and up to or more than the amount naturally present in whole eggs and in the yolk.

In accordance with the present invention, to avoid off-flavors or a spinach-like taste, when the amount of choline is greater than 75 mg per 60 g serving size, a masking agent for the choline may be included in the fortified yolk-less liquid egg product, and cooked egg products containing or made with it, in a taste masking amount of the masking agent for the choline. Off-flavors due to choline and taste masking effective amounts of a masking agent for the off-flavors or spinach taste may be determined using an expert taste panel of for example 5 or more trained taste panel experts. In embodiments the amount of choline may be from 105 mg to 230 mg per 60 g serving size. Preferably the amount of choline is from 50% by weight to 110% by weight of the choline of a natural whole egg, more preferably the amount of choline is that of a natural whole egg or more.

In embodiments, the egg whites employed are 100% egg whites, which are commercially available. The amount of egg whites may be from 75% by weight to 99% by weight, for example, from 85% by weight to 95% by weight, based upon the weight of the liquid egg product or cooked egg product containing it. The choline employed may be pure choline or in the form of one or more edible choline salts, such as choline chloride, choline citrate, or choline bitartrate, and mixtures thereof.

The masking agent for the choline may be any process compatible flavoring, or a film-forming component or protective coating which encapsulates the choline which is employed in an effective choline masking amount. Exemplary amounts of the masking agent may be at least 0.1% to 100% or more, based upon the weight of the choline. For example, in embodiments the amount of masking agent may generally be from 0.5% by weight to 75% by weight, or from 1% by weight to 20% by weight, based upon the weight of the choline. In other embodiments, the amount of masking agent may be employed in a weight ratio of choline to masking agent of from 0.1:10, for example 1:5.

Exemplary flavorings which may be employed include at least one of egg-compatible seasonings, spices, peppers, or vegetables, such as southwestern seasonings, jalapeno pepper, onion, cheese, tomato, spinach, mushroom, milk powders, vanilla, and cocoa.

The protective coating which may be employed may be hydrophilic or oleophobic. Exemplary film-building substances or protective coatings which may be employed are a protein stemming from whey, corn, wheat, soy, or other vegetable or animal sources, such as zein and denatured whey protein isolate solution, a fat, such as melted chocolate fat, shellac, wax, film-forming starch solutions, alginates, other non-starch polysaccharides, an enteric coating, and mixtures thereof. Film-forming components which may be employed include, but are not limited to, proteins; carbohydrates; hydrocolloids, such as alginates, carrageenans, and gums; polysaccharides, starches, such as modified starch and starch derivatives; such as maltodextrins, or mixtures thereof. Exemplary proteins which may be employed are one or more vegetable proteins, dairy proteins, animal proteins, or protein concentrates, such as proteins stemming from milk, whey, corn, wheat, soy, or other vegetable or animal sources. Dairy proteins which may be employed include caseinates, such as sodium caseinate, potassium caseinate, calcium caseinate, and ammonium caseinate, whey protein isolates, and wheat protein isolates, such as gluten.

In embodiments of the invention, the fortified yolk-less egg product and cooked egg products containing it also include nutritionally effective amounts of at least one polyunsaturated fatty acid (PUFA), such as at least one omega-3 fatty acid for their beneficial brain and cardiovascular health, lutein for its beneficial eye benefits, beta-carotene for its egg yolk color, and vitamins and minerals. In embodiments, the fortified yolk-less egg product and cooked egg products containing it are cholesterol free and/or triglyceride free and include at least 50% by weight, preferably at least 100% by weight of the natural amount of at least three nutritional components of a natural egg yolk which are not present in natural egg white.

Polyunsaturated fatty acids and oils which contain them which may be employed include castor oil, algae-based oil or oil derived from algae, flax oil or flax seed oil, fish oil, seed oil, oil from microorganisms, or any other oil containing polyunsaturated fatty acids (PUFA) such as omega-3 fatty acids, eicosapentaenoic acid (EPA), docosahexaenoic acid (DHA), docosapentaenoic acid, and linolenic acid, alpha-linolenic acid, conjugated linolenic acid, gamma linolenic acid, and omega-6 fatty acids. DHA is a preferred omega-3 fatty acid for use in the egg products of the present invention. In embodiments of the invention, the amount of the at least one omega-3 fatty acid may be from 20 mg to 300 mg per 60 g serving, for example from 30 mg to 75 mg per 60 g serving.

The lutein may be employed in an amount of from 0.1 mg to 0.4 mg per 60 g serving, and the amount of beta-carotene may be employed in an amount sufficient to provide the yellow appearance of an egg yolk. Exemplary amounts of beta-carotene which may be employed are from 10 IU to 1,000 IU per 60 g serving.

Exemplary of vitamins and minerals which may be employed in the fortified yolk-less liquid egg product and cooked egg products containing it include nutritional effective amounts of Biotin (Vitamin H), d-Calcium Pantothenate (Vit B5), Ferric Orthophosphate, Folic Acid, Pyridoxine Hydrochloride (Vit B6), Riboflavin (Vit B2), Thiamine Mononitrate (Vit B1), Cholecalciferol, (Vit D3), Vitamin B12,Vitamin E, Zinc Sulfate (as Zinc), Copper, and Selenium (as Sodium Selenite). The vitamins and minerals may be employed in a premix which may include a carrier such as maltodextrin. The premix may also contain the Beta Carotene and the Lutein. The premix may be formed by dry blending in conventional manner. In preferred embodiments, the amounts of copper and zinc may each be equal to or greater than the amounts naturally present in a whole egg.

In embodiments the fortified yolk-less liquid egg product may include one or more amino acids in an amount each equal to or greater than the amount naturally present in a whole egg. Exemplary amino acids which may be employed are disclosed in the Table at page 4 of U.S. Patent Application Publication No. 2008/0003335, which is herein incorporated by reference in its entirety.

Added water, which is water added in addition to the water naturally included in the egg whites, may be provided in the fortified yolk-less liquid egg product. The amount of added water may be up to the same or more than the amount of water present in a natural whole egg. In embodiments of the invention, the amount of added water may range from 5 g to 25 g, preferably from 10 g to 20 g, per 60 g serving size.

The present invention also provides cooked food products which include the cooked fortified yolk-less liquid egg product. Exemplary of preferred cooked food products of the present invention include egg patties, muffins, muffin sandwiches, omelets, baked goods, pizza, and pastries, each of which are preferably frozen. The fortified yolk-less liquid egg product may admixed with conventional ingredients in conventional amounts employed for whole eggs in the food product, and then the composition may be cooked to obtain the cooked egg product. Exemplary of additional ingredients which may be included in the cooked food products are at least one ingredient which is a gum, such as guar gum, and xanthan gum, natural flavors, artificial flavors, artificial or natural sweeteners, sugar, oil, onion powder, fiber, or mixtures thereof. In embodiments of the invention, one or more emulsifiers such as lecithin, may be employed in conventional emulsifying amounts to prevent separation of oil and water components in the egg products.

In embodiments of the invention, as shown in FIG. 1 a fortified yolk-less liquid egg product may be produced by admixing liquid egg white, at least one omega-3 fatty acid, lutein, beta-carotene, vitamins and minerals, and choline to obtain a homogeneous blend, wherein the amount of choline is at least 25 mg per 60 g serving size of the liquid egg product, and when the amount of choline is greater than 75 mg per 60 g serving size, the egg product further includes a taste masking amount of a masking agent for the choline, pasteurizing the blend, cooling the pasteurized blend, and packaging the cooled blend. As shown in FIG. 1, the liquid egg white and dry ingredients may be combined in a chilled mixer and mixed under high shear until blended or homogeneous. The liquid ingredients, including the omega-3 fatty acids, such as algae oil, may be admixed with the blended, homogeneous mixture for several minutes to obtain a homogeneous egg composition. The homogeneous egg composition may be pasteurized to obtain a pasteurized egg composition. Exemplary pasteurization conditions include heating at from 135° F. to 150° F. for 1 to 8 minutes. The pasteurized egg composition may be cooled in a cooling device to 39° F. to 45° F. and then packaged, into a package such as gable-top cartons.

In another embodiment, as shown in FIG. 2, the fortified yolk-less liquid egg product may be produced as described for the FIG. 1 embodiment, except the at least one omega-3 fatty acid may be admixed with the cooled pasteurized egg composition rather than being admixed with the liquid ingredients prior to pasteurization. In this process the omega-3 fatty acids are not subjected to the heat of pasteurization which could oxidize the free fatty acids and cause rancidity. The oil containing the omega-3 fatty acids may be injected into the process line for admixture with the cooled pasteurized egg composition using sterile injection, such as with a sterile syringe.

The liquid egg products of the present invention may be stored under refrigerated condition of 5 weeks or more with less than 3% loss of omega-3 fatty acids. The cooked egg products containing the fortified yolk-less liquid egg product, such as egg patties, may be stored frozen for extended periods of time, for example at least three months.

In embodiments of the invention, a fortified yolk-less food product may be produced by admixing a fortified yolk-less liquid egg product with at least one ingredient which is a gum, natural flavoring, artificial flavoring, sweetener, sugar, oil, or mixtures thereof to obtain a homogeneous liquid egg product, and cooking the liquid egg product to obtain a yolk-less food product with a choline content of at least 25 mg per 60 g serving size, based upon the weight of the food product. The yolkless food product may be formed into pieces and frozen. In embodiments, the amount of choline may be from 25 mg to 75 mg per 60 g serving size. In other embodiments, the amount of choline may be greater than 75 mg per 60 g serving size and the may include a masking agent in a choline masking effective amount. In embodiments the vitamins, minerals, beta-carotene and lutein may be preblended prior to admixing with the at least one omega-3 fatty acid and the choline.

In other embodiments a fortified yolk-less egg patty may be produced by admixing egg whites, water, at least one omega-3 fatty acid, lutein, beta-carotene, vitamins and minerals, and choline to obtain a homogeneous liquid egg product wherein the amount of choline is at least 25 mg per 60 g serving size of the liquid egg product, and when the amount of choline is greater than 75 mg per 60 g serving size, the egg product further includes a taste masking amount of a masking agent for the choline, pouring the liquid egg product into a mold, and cooking the liquid egg product in the mold to obtain a yolk-less egg patty with a choline content of at least 25 mg per 60 g serving size, based upon the weight of the egg patty. The yolkless egg patty may be frozen after removal from the mold. In embodiments, the amount of choline may be from 25 mg to 75 mg per 60 g serving size and a choline masking agent is not employed. In other embodiments the amount of choline may be greater than 75 mg per 60 g serving size. The vitamins, minerals, beta-carotene and lutein may be preblended prior to admixing with the at least one omega-3 fatty acid and the choline.

The present invention is further illustrated by the following non-limiting examples where all parts, percentages, proportions, and ratios are by weight, all pressures are atmospheric, and all temperatures are in ° F. unless otherwise indicated:

### Example 1

In this example, an egg white patty is produced which is fortified with lutein, choline, DHA (50 mg/60 g serving), beta-carotene, vitamins and minerals, and the appearance and taste of the product are evaluated by a taste panel. The example demonstrates the feasibility of fortifying an egg white patty with nutrient premixes and DHA (50 mg/serving). Informal bench tasting showed that the nutrients added to the egg white patty did not have a significant impact on taste and were acceptable. Egg white patty variant 7 containing the premix, lutein, choline, DHA, and beta carotene was acceptable in flavor. The appearance, however, was impacted by the nutrient premix. The egg white patty turned slightly yellow from the presence of riboflavin in the premix. This impact was acceptable because it was desired that the final appearance should resemble a whole egg patty. In fact, additional beta carotene (3% CWS/M) was required to do this completely to obtain an acceptable egg yolk color.

### Materials & Methods:

TABLE 2
Egg Patty Formula: (1 serving, serving size of 60 grams)

| Ingredient | Grams |
|---|---|
| All Natural 100% Liquid Egg Whites | 44.0000 |
| Water | 15.0000 |
| Vitamin and Mineral Premix | 0.0150 |
| Lutein, 10% v/tg | 0.0004 |
| Choline | 0.0250 |
| DHA S Oil (50 mg) | 0.1430 |
| DHA S Oil (100 mg) | 0.2860 |
| BC 3% CWS/M (750 IU Vit. A) | 0.0150 |

To prepare the egg white patty the following steps were taken; all steps were repeated for each variant:

1. In a small bowl, weigh out the egg whites.

2. Add 1 tablespoon of water.

3. Add any additional fortifications including the premix, lutein, choline, and DHA.

4. Using a small whisk, mix all ingredients until fully dissolved being careful not to incorporate too much air.

5. Using an egg poaching pan, fill the bottom with water and bring to a boil.

6. Spray the poaching cups with non-stick cooking spray and pour the egg mixture into one of the poaching cups.

7. Cover and steam over medium heat for 6 minutes, until fully cooked.

8. Remove from heat, and place egg patty on a serving dish.

The egg patty vitamin and mineral premix formula is shown in Table 3:

TABLE 3
Egg Patty Vitamin and Mineral Premix A(Use Rate 15 mg)

| Ingredient | Amount | | % DV |
|---|---|---|---|
| Biotin (Vitamin H) | 0.02 | mg | 6.67 |
| d-Calcium Pantothenate (Vit B5) | 1.00 | mg | 10.00 |
| Ferric Orthophosphate | 1.08 | mg | 6.00 |
| Folic Acid 10% (maltodextrin | 0.06 | mg | 15.00 |
| Pyridoxine Hydrochloride (Vit B6) | 0.08 | mg | 4.00 |
| Riboflavin (Vit B2) | 0.85 | mg | 50.00 |
| Thiamine Mononitrate (Vit B1) | 0.15 | mg | 10.00 |
| Cholecalciferol, (Vit D3) 100 SD/s | 40.00 | IU | 10.00 |
| (Vit D3) | | | |
| Vitamin B12 0.1% WS | 1.20 | mcg | 20.00 |
| Vitamin E 50% CWS/S | 1.20 | IU | 4.00 |
| Zinc Sulfate (as Zinc) | 0.60 | mg | 4.00 |

| | |
|---|---|
| Carrier (Maltodextrin 15 DE) | Q.S. |

### Experimental Variants

Seven different variants were produced (Serving size per egg patty: about 59 grams)

1. Egg whites+water
2. Egg whites+water+Premix A (15 mg/svg)
3. Egg whites+water+Premix A (15 mg/svg)+lutein 10% (0.4 mg/svg)
4. Egg whites+water+Premix A (15 mg/svg)+choline (25 mg/svg)
5. Egg whites+water+Premix A (15 mg/svg)+DHA S Oil (50 mg/svg)
6. Egg whites+water+Premix A (15 mg/svg)+DHA S Oil (100 mg/svg)
7. Egg whites+water+Premix A (15 mg/svg)+lutein+choline+DHA+Beta Carotene

### Results & Discussion:

### Physical Characteristics and Color

A previous brain health premix formulated for the egg white patties was not suitable due to the color impact from riboflavin (too yellow) and higher than desired nutrient levels. The reduced level of riboflavin in Premix A still resulted in a yellow hue in the egg white patties. However, this was desirable for the egg white patty to have the appearance of a whole egg patty. Further, to meet this expectation, an additional 15 mg of Beta Carotene 3% was added per serving. The additional beta carotene delivered 750 IU Vitamin A per serving.

Informal bench tasting showed that the nutrients added to the egg white patty did not have a significant impact on taste and were acceptable. Even variant 7 containing the premix, lutein, choline, DHA, and beta-carotene was acceptable.

### CONCLUSION

The egg white patties met the criteria of an acceptable product based on taste and physical attributes.

### Example 2

In this example the levels of choline and DHA are evaluated with a different egg patty vitamin and mineral premix (Premix B). Premix B contains added selenium and copper to Premix A and iron is removed. Premix B also includes the previously separately added lutein and beta carotene. The premix concept consisted of building the nutritional value of a whole egg in an egg white patty application.

Seven new experimental variants of egg white patties were produced and tasted. The Example 1 version containing Premix A, 100 mg DHA, choline, lutein and Beta Carotene separately was included. This variant was compared to others containing Premix B with different levels of DHA (50 mg, 100 mg and 160 mg), an unfortified egg white patty, and a whole egg patty as control. An additional variant was added containing 150 mg of choline per egg. Premix B delivered 750 IU of Vitamin A per serving (reflecting the nutritional value of a whole egg) but this resulted in a much brighter and yellow egg patty than the patty of Example 1. The samples were bench tasted in the lab and all variants were acceptable in the tasting despite the color difference. The variant containing the highest dose of DHA at 160 mg per serving did have slight fishy off notes, but the taste paired well with the sulfuric notes often perceived in egg products.

### Materials and Methods:

The Premix B formula is presented in Table 4:

TABLE 4
Egg Patty Vitamin and Mineral Premix B(Use Rate 42 mg)

| Ingredient | Amount | | % DV |
|---|---|---|---|
| Biotin (Vitamin H) | 0.02 | mg | 6.67 |
| d-Calcium Pantothenate (Vit B5) | 1.00 | mg | 10.00 |
| Copper (as Copper Sulfate) | 0.04 | mg | 2.00 |
| Folic Acid (Vit B9) | 0.06 | mg | 15.00 |
| Pyridoxine Hydrochloride (Vit B6) | 0.08 | mg | 4.00 |
| Riboflavin (Vit B2) | 0.85 | mg | 50.00 |
| Thiamine Mononitrate (Vit B1) | 0.15 | mg | 10.00 |
| Cholecalciferol, (Vit D3) | 40.00 | IU | 10.00 |
| Cyanocobalamin (Vitamin B12) | 1.20 | mcg | 20.00 |
| Vitamin E 50% CWS/S | 1.20 | IU | 4.00 |
| Zinc Sulfate (as Zinc) | 0.60 | mg | 4.00 |
| Selenium (as Sodium Selenite) | 14 | mcg | 20.00 |
| Beta Carotene | 750 | IU | 15.00 |
| Lutein | 0.40 | mg | — |

| | |
|---|---|
| Carrier (Maltodextrin 15 DE) | Q.S. |

### Variants

100451 Using the egg white patty formula and directions of Example 1, seven different variants were prepared:
1. Egg whites (44 g)+water
2. Egg whites (44 g)+water+Premix A (15 mg)+lutein (0.4 mg)+choline (25 mg)+DHA (100 mg)+Beta Carotene (15 ul)
3. Egg whites (44 g)+water+Premix B (42 mg)+choline (25 mg)+DHA (50 mg)
4. Egg whites (44 g)+water+Premix B (42 mg)+choline (25 mg)+DHA (100 mg)
5. Egg whites (44 g)+water+Premix B (42 mg)+choline (25 mg)+DHA (160 mg)
6. Egg whites (44 g)+water+Premix B (42 mg)+choline (150 mg)+DHA (100 mg)

### 7. Whole Egg

### Results and Discussion:

All variants were acceptable in the lab tastings. Any perceived off notes from the DHA or minerals paired well with the sulfuric notes often perceived in egg products. The higher Beta Carotene (at 750 IU per serving) delivered a brighter, yellower egg patty but met the nutritional value of a natural whole egg. It was noted that when serving variant 6 there was a small amount of moisture in the serving dish (plastic weigh boat). It is possible that some emulsification might be necessary when incorporating the ‘fat’ type ingredients such as choline and DHA. However, it should also be noted that some of the egg white patties were re-heated in second test in a microwave covered by another plastic weigh boat; it is possible that this was just condensation from the re-heating procedure.

What is claimed is:

1. A fortified yolk-less liquid egg product comprising egg whites, at least one omega-3 fatty acid, lutein, beta-carotene, vitamins and minerals, and choline wherein the amount of choline is at least 25 mg per 60 g serving size of the liquid egg product, and when the amount of choline is greater than 75 mg per 60 g serving size, the egg product further includes a taste masking amount of a masking agent for the choline.

2. A fortified yolk-less egg product as claimed in claim 1 wherein the amount of choline is from 25 mg to 75 mg per 60 g serving size.

3. A fortified yolk-less egg product as claimed in claim 2 wherein the amount of choline is from 35 mg to 60 mg per 60 g serving size.

4. A fortified yolk-less egg product as claimed in claim 1 wherein the amount of choline is greater than 75 mg per 60 g serving size.

5. A fortified yolk-less egg product as claimed in claim 1 wherein the amount of choline is from 105 mg to 230 mg per 60 g serving size.

6. A fortified yolk-less egg product as claimed in claim 4 having from 50% by weight to 110% by weight of the choline of a natural whole egg.

7. A fortified yolk-less egg product as claimed in claim 4 wherein the amount of choline is that of a natural whole egg.

8. A fortified yolk-less egg product as claimed in claim 4 wherein the masking agent comprising a flavoring.

9. A fortified yolk-less egg product as claimed in claim 4 wherein the masking agent comprises a film-forming component or protective coating which encapsulates the choline.

10. A fortified yolk-less egg product as claimed in claim 1 wherein the choline is in the form of an edible choline salt.

11. A fortified yolk-less egg product as claimed in claim 10 wherein the edible choline salt is at least one of choline chloride, choline citrate, or choline bitartrate.

12. A fortified yolk-less egg product as claimed in claim 1 which is pasteurized and wherein the beta-carotene is present in an amount sufficient to provide the yellow appearance of an egg yolk.

13. A fortified yolk-less egg product as claimed in claim 1 which is cholesterol free and triglyceride free and which comprises at least 50% by weight of the natural amount of at least three nutritional components of a natural egg yolk which are not present in natural egg white.

14. A fortified yolk-less egg product as claimed in claim 1 which is cholesterol free and triglyceride free and which comprises at least the natural amount of at least three nutritional components of a natural egg yolk which are not present in natural egg white.

15. A fortified yolk-less egg product as claimed in claim 1 wherein the amount of egg whites is from 75% by weight to 99% by weight, based upon the weight of the egg product.

16. A fortified yolk-less egg product as claimed in claim 8 wherein the flavoring comprises at least one of a seasoning, a spice, a pepper, or a vegetable.

17. A fortified yolk-less egg product as claimed in claim 9 wherein the film-forming component or protective coating comprises at least one of a protein, fat, polysaccharide, or hydrocolloid.

18. A fortified yolk-less egg product as claimed in claim 1 wherein the amount of the at least one omega-3 fatty acid is from 20 mg to 300 mg per 60 g serving, the amount of lutein is from 0.1 mg to 0.4 mg per 60 g serving, and the amount of beta-carotene is from 10 IU to 1,000 IU per 60 g serving.

19. A fortified yolk-less egg product as claimed in claim 18 further comprising water, a maltodextrin, selenium, copper, and zinc where the amounts of copper and zinc are each equal to or greater than the amounts naturally present in a whole egg.

20. A fortified yolk-less egg product as claimed in claim 1 comprising one or more amino acids in an amount each equal to or greater than the amount naturally present in a whole egg.

21. A food product comprising a fortified yolk-less liquid egg product as claimed in claim 1 which is cooked.

22. A food product comprising a fortified yolk-less liquid egg product as claimed in claim 2 which is cooked.

23. A food product comprising a fortified yolk-less liquid egg product as claimed in claim 4 which is cooked.

24. A food product as claimed in claim 21 further comprising at least one ingredient which is a gum, natural flavoring, artificial flavoring, sweetener, sugar, oil, or mixtures thereof.

25. A food product as claimed in claim 21 which is an egg patty.

26. A food product as claimed in claim 22 which is an egg patty.

27. A food product as claimed in claim 23 which is an egg patty.

28. A food product as claimed in claim 24 which is an egg patty.

29. A food product as claimed in claim 25 which is frozen.

30. A method for making a fortified yolk-less liquid egg product as claimed in claim 1 comprising admixing liquid egg white, at least one omega-3 fatty acid, lutein, beta-carotene, vitamins and minerals, and choline to obtain a homogeneous blend, wherein the amount of choline is at least 25 mg per 60 g serving size of the liquid egg product, and when the amount of choline is greater than 75 mg per 60 g serving size, the egg product further includes a taste masking amount of a masking agent for the choline, pasteurizing the blend, cooling the pasteurized blend, and packaging the cooled blend.

31. A method for making a fortified yolk-less liquid egg product as claimed in claim 30 wherein the at least one omega-3 fatty acid is admixed after said cooling of the pasteurized blend.

32. A method for making a fortified yolk-less liquid egg product as claimed in claim 30 wherein the amount of choline is from 25 mg to 75 mg per 60 g serving size.

33. A method for making a fortified yolk-less liquid egg product as claimed in claim 30 wherein the amount of choline is greater than 75 mg per 60 g serving size.

34. A method for making a fortified yolk-less liquid egg product as claimed in claim 30 wherein the vitamins, minerals, beta-carotene and lutein are preblended prior to admixing with the at least one omega-3 fatty acid and the choline.

35. A method for making a fortified yolk-less food product comprising cooking a fortified yolk-less liquid egg product as claimed in claim 1.

36. A method for making a fortified yolk-less food product comprising admixing a fortified yolk-less liquid egg product as claimed in claim 1 with at least one ingredient which is a gum, natural flavoring, artificial flavoring, sweetener, sugar, oil, or mixtures thereof to obtain a homogeneous liquid egg product, and cooking the liquid egg product to obtain a yolk-less food product with a choline content of at least 25 mg per 60 g serving size, based upon the weight of the food product.

37. A method for making a fortified yolk-less food product as claimed in claim 36 wherein the yolkless food product is formed into pieces and frozen.

38. A method for making a fortified yolk-less food product as claimed in claim 35 wherein the amount of choline is from 25 mg to 75 mg per 60 g serving size.

39. A method for making a fortified yolk-less food product as claimed in claim 35 wherein the amount of choline is greater than 75 mg per 60 g serving size.

40. A method for making a fortified yolk-less food product as claimed in claim 35 wherein the vitamins, minerals, beta-carotene and lutein are preblended prior to admixing with the at least one omega-3 fatty acid and the choline.

41. A method for making a fortified yolk-less egg patty comprising admixing egg whites, water, at least one omega-3 fatty acid, lutein, beta-carotene, vitamins and minerals, and choline to obtain a homogeneous liquid egg product wherein the amount of choline is at least 25 mg per 60 g serving size of the liquid egg product, and when the amount of choline is greater than 75 mg per 60 g serving size, the egg product further includes a taste masking amount of a masking agent for the choline, pouring the liquid egg product into a mold, and cooking the liquid egg product in the mold to obtain a yolk-less egg patty with a choline content of at least 25 mg per 60 g serving size, based upon the weight of the egg patty.

42. A method for making a fortified yolk-less egg patty as claimed in claim 41 wherein the yolkless egg patty is frozen after removal from the mold.

43. A method for making a fortified yolk-less liquid egg product as claimed in claim 41 wherein the amount of choline is from 25 mg to 75 mg per 60 g serving size.

44. A method for making a fortified yolk-less liquid egg product as claimed in claim 41 wherein the amount of choline is greater than 75 mg per 60 g serving size.

45. A method for making a fortified yolk-less liquid egg product as claimed in claim 41 wherein the vitamins, minerals, beta-carotene and lutein are preblended prior to admixing with the at least one omega-3 fatty acid and the choline.
